(19) United States
(12) Patent Application Publication
(10) Pub. No.: US 2007/0170128 A1
(43) Pub. Date: Jul. 26, 2007

(54) Retainer arrangement for engagement with the end of an elongated article, such as a firearm or related accessory

(76) Inventor: William H. Punzel, Edgerton, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/340,240

(22) Filed: Jan. 26, 2006

(51) Int. Cl. B60R 7/14

(52) U.S. Cl. 211/64

(57) ABSTRACT

A retainer arrangement for selectively engaging the end of an article includes a cradle member having an open recess configured to receive the article at a location adjacent the end of the article, and a retainer member that is movable between an open position in which the retainer member allows the article to be placed into or removed from the recess, and a closed position in which the retainer member maintains the article within the recess. The retainer member is releasably engaged with the cradle member when in the closed position, and engages the article to prevent outward movement of the article from the recess. The member has a pair of arms that define the recess, and also includes an upper wall above the pair of arms. The retainer member is pivotably mounted to the upper wall of the cradle member for movement between the open and closed positions, and is formed of a resilient material to enable the retainer member to stretch when moved to its closed position, to enable the retainer member to be moved into engagement with a latching arrangement carried by the cradle member.

### BACKGROUND AND SUMMARY OF THE INVENTION

This invention relates to a releasable retainer for engagement with an article, such as the barrel of a rifle or other firearm supported by a weapons rack or cabinet, for maintaining the article in an upright position.

A wide variety of firearms, such as rifles, machine guns or related accessories, are often employed in military applications and must be stored when not in use. It is known to provide a rack or cabinet for supporting the firearms or related accessories when not in use. The rack or cabinet (hereafter referred to as a rack for simplicity) is configured to maintain the firearms or accessories in an upright position via a lower support that engages and supports the lower end of the article, which extends upwardly from the lower support. The rack also has an upper support, in the form of a barrel rest, that receives and engages the article at a location above the lower support, typically toward the upper end of the article.

It is an object of the present invention to provide a releasable retainer for maintaining an article such as a rifle, machine gun, or accessory in an upright position. Another object of the invention is to provide such a retainer which can be quickly and easily moved between an open position for enabling the article to be engaged or removed from the upper support, and a closed position for maintaining the article in engagement with the upper support. It is a further object of the invention to provide such a releasable retainer which can be used with a conventionally configured support while selectively securing the article to the support. A still further object of the invention is to provide such a retainer which can accommodate differently dimensioned articles. Yet another object of the invention is to provide such a retainer which securely maintains the article in engagement with the support without scratching or marring the surface of the article.

In accordance with the present invention, an article retainer includes structure defining a recess within which the article is received, and a movable, releasable retainer member that is movable between an open position for enabling the article to be received within or removed from the recess, and a closed position for engaging the article. The retainer member may be moved to a latched position when closed, to secure the retainer member against movement and to maintain the article within the recess. The recess may be defined by a cradle or bracket member having a pair of arms, and which also includes an upper wall that overlies the pair of arms and the upper end of the article when the upper end of the article is engaged within the recess. The movable retainer member is pivotably mounted to the upper wall for movement between the open and closed positions. The retainer member includes a mounting section located within a recess defined by the upper wall, and an engagement section spaced from the mounting section and configured to engage the article at a location spaced from the upper wall. The retainer member also includes a latching section that releasably engages the cradle or bracket member to releasably maintain the retainer member in the latched position when closed. The engagement section of the retainer member is in alignment with the recess, and is configured to engage the article so as to maintain the article in the recess when the retainer member is in the closed position. In one embodiment, the retainer member is movable between the open and closed positions by pivotal movement of the mounting section of the retainer member relative to the cradle.

The retainer member is preferably formed of a resilient, stretchable material. The retainer member includes a transverse retaining or latching pin that engages a recess in the cradle when the retainer member is stretched and placed in the closed position. The stretch of the retainer member maintains the retainer member in the latched, closed position while the engagement section of the retainer member resiliently engages the article. The retainer member further includes a finger grip section, which is employed by the user to move the retainer member between the open and closed positions, and to apply tension to the retainer member so as to stretch the retainer member as the retainer member is moved from the open position to the closed position and vice versa.

The article retainer may be used to engage and maintain the upper end of an article, such as a firearm in the form of a rifle or machine gun, or a related component or accessory, in an upright position in or on a cabinet or rack. The article retainer provides easy access to the article when desired, as well as a quick and easy way to secure the article in position. The article retainer is particularly well suited for use in a military environment, in which it is important to secure firearms and accessories in position while providing quick and easy removal from, and engagement with, the cabinet or rack.

The invention also contemplates a method of releasably maintaining an article in position on a support, substantially in accordance with the foregoing summary.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is an isometric view of a support arrangement incorporated in a cabinet or rack for storing firearms or related accessories in an upright orientation;

FIG. 2 is an enlarged partial isometric view of a pair of article retainers, in accordance with the present invention and forming a part of the support arrangement of FIG. 1, which are engageable with the upper ends of the articles to maintain the articles upright;

FIG. 3 is an isometric view of a cradle or bracket member forming a part of the article retainer of FIG. 2;

FIG. 4 is an isometric view of a retainer member incorporated in the article retainer of FIG. 2;

FIGS. 5 and 6 are side elevation views showing the article retainer of FIG. 2 and movement of the retainer member of FIG. 4 to a closed position on the cradle or bracket member of FIG. 3, for releasably engaging the upper end of the article with the article retainer;

FIG. 7 is a view similar to FIG. 6, showing movement of the cradle or bracket member relative to the support rail to vary the elevation of the cradle or bracket member;

FIG. 8 is an isometric view similar to FIG. 2, illustrating another embodiment of the cradle or bracket member and the retainer member for retaining the upper end of a different type of firearm;

FIG. 9 is an isometric view of the cradle or bracket member incorporated in the article retainer of FIG. 7;

FIG. 10 is an isometric view of the retainer member incorporated in the article retainer of FIG. 7;

FIGS. 11 and 12 are side elevation views illustrating movement of the retainer member of FIG. 10 to a closed position on the cradle or bracket member of FIG. 9 for engaging the upper end of the firearm;

FIG. 13 is an isometric view of another embodiment of an article retainer in accordance with the present invention for retaining the upper end of a different type of firearm, showing the retainer member in a latched position; and

FIG. 14 is an isometric view of a bracket member incorporated in the article retainer of FIG. 13.

### DETAILED DESCRIPTION OF THE INVENTION

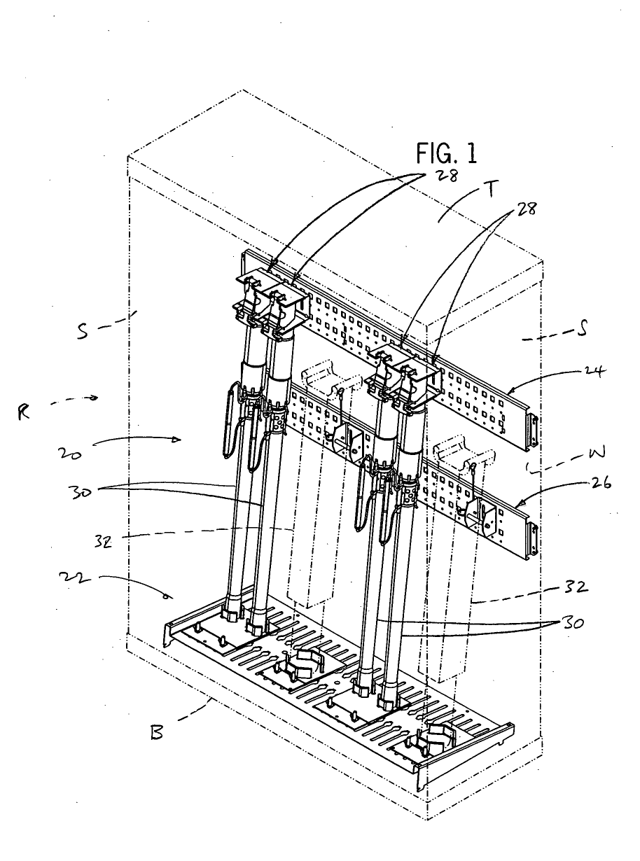

Referring to FIG. 1, a support arrangement for firearms or related accessories is shown generally at 20. Support arrangement 20 is especially well suited for maintaining firearms such as rifles, machine guns or related accessories or components in an upright orientation within an enclosure such as a cabinet or rack, shown in phantom at R (hereafter referred to as rack R for simplicity). The construction of rack R is shown and described in copending application Ser. No. 10/542,129 filed Jul. 13, 2005 (priority application PCT/US2004/009142 filed Mar. 25, 2004), the disclosure of which is hereby incorporated by reference. Generally, rack R includes a bottom B, a top T, a pair of sides S and a back wall W, which cooperate to define an interior within which support arrangement 20 is located.

Support arrangement 20 includes a lower end support 22 and a pair of upper supports located above lower end support 22. The upper supports include an upper support rail 24 and a lower support rail 26.

Upper support rail 24 and lower support rail 26 define spaced apart ends that are mounted to corner posts associated with cabinet or rack R. As shown and described in the copending '129 patent application, upper support rail 24 and lower support rail 26 can be adjustably mounted at different heights within the interior of rack R, according to the configuration of the articles to be stored within the interior of rack R. A series of article retainers, in the form of upper retainer assemblies 28 in accordance with the present invention, are mounted to upper support rail 24. In a manner to be explained, each retainer assembly 28 is configured to receive and engage the upper end of an article contained within the interior of rack R. As shown in FIG. 1, the articles are in the form of gun barrels 30 which are adapted to be assembled to gun bodies 32, which are contained within the interior of rack R. Other types of firearms or related accessories can also be contained within the interior of rack R and supported by support arrangement 20.

Each gun barrel 30 or gun body 32 defines a lower end that is engaged with and supported by lower support 22, and an upper end spaced above the lower end. The upper end of each gun body 32 is engaged with lower rail 26 so as to be maintained in an upright orientation within the interior of rack R. The upper end of each gun barrel 30 is engaged with one of upper retainer assemblies 28, to maintain the gun barrels 30 in an upright orientation within the interior of rack R.

The construction and operation of lower support 22 is shown and described in copending application Ser. No. ______ filed ______ (atty docket no. 353.315), the disclosure of which is hereby incorporated by reference. It is understood, however, that the lower ends of gun barrels 30 and gun bodies 32 may be secured in any satisfactory manner so as to support gun barrels 30 and gun bodies 32 in the upright orientation as shown.

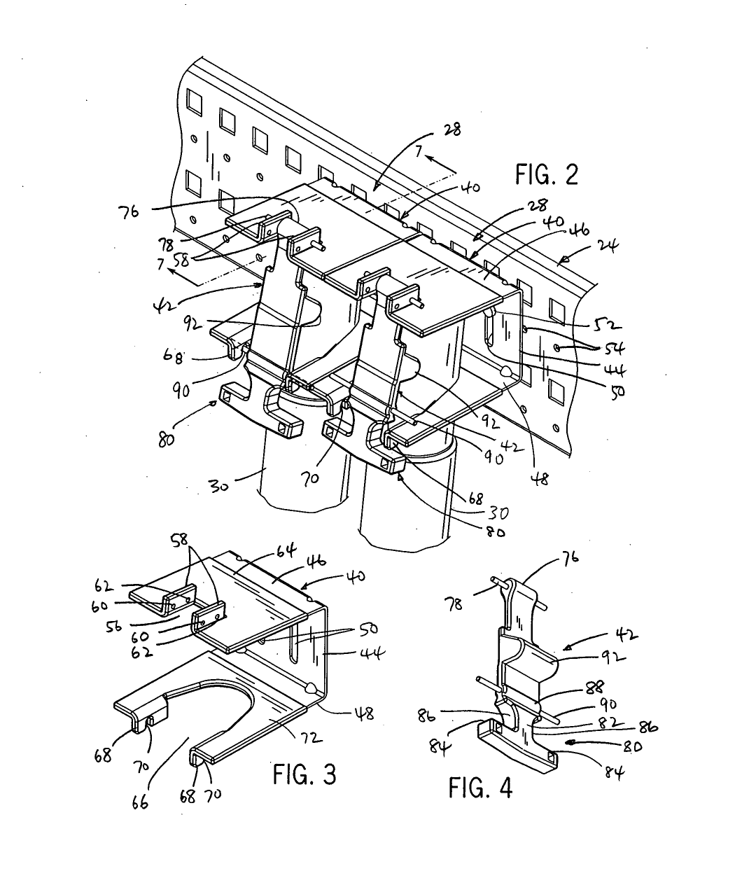

Referring to FIGS. 2-4, and in accordance with the present invention, each upper retainer assembly 28 generally includes a retainer cradle or bracket 40 and a retainer member 42 that is movably mounted to retainer bracket 40.

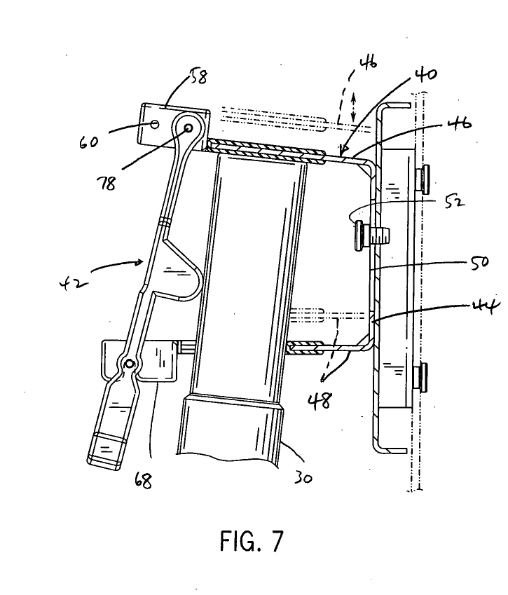

Retainer bracket 40 includes a generally vertical mounting wall 44, an upper wall 46 that extends outwardly from the upper end of mounting wall 44, and a lower wall 48 that extends outwardly from the lower end of mounting wall 44. A pair of vertical slots 50 are formed in mounting wall 44. A fastener, such as a screw 52, is adapted to extend through each of slots 50 and into engagement with one of a series of transversely spaced openings 54 in upper support rail 24, for securing retainer bracket 40 to upper support rail 24. It is understood, however, that retainer bracket 40 may be secured in position within the interior of cabinet or rack R in any other satisfactory manner. As shown in FIG. 7, slots 50 enable retainer bracket 40 to be moved to different elevations relative to support rail 24, by moving retainer bracket 40 upwardly or downwardly along the length of slots 50.

In the illustrated embodiment, retainer bracket 40 is constructed of a relatively rigid material such as sheet metal, which is formed in a stamping and bending operation so as to provide the desired end configuration of retainer bracket 40. It is understood, however, that retainer bracket 40 may be formed of any other satisfactory material using any other satisfactory forming method.

Upper wall 46 of retainer bracket 40 includes a generally rectangular recess 56 that extends inwardly from the front edge of upper wall 46. Recess 56 is bounded by a pair of upstanding mounting tabs 58, which may be formed of bent portions of upper wall 46 that are cut and formed in the stamping operation in which retainer bracket 40 is formed. Each mounting tab 58 defines a front aperture 60 and a rear aperture 62.

A resilient material 64 is applied to the front area of upper wall 46, such as in a coating or dipping operation. The resilient material may be a material such as urethane, and provides a cushion layer that overlies the top and bottom surfaces of upper wall 46 as well as mounting tabs 58 and the various surfaces and edges of upper wall 46.

Lower wall 48 of retainer bracket 40 is formed with a recess 66 that extends inwardly from the front edge of lower wall 48. A pair of downwardly extending latch ears 68 are formed at the front area of recess 66. Again, latch ears 68 may be formed of bent portions of lower wall 48 that are cut and formed in the stamping operation in which retainer bracket 40 is formed. Each latch ear 68 includes a downwardly facing notch 70. As with upper wall 48, a resilient material 72, such as urethane, is applied to the front area of lower wall 48, such as in a coating or dipping operation. The resilient material 72 is preferably the same material as is used to cover the forward areas of upper wall 46. Again, the resilient material 72 functions to provide resilient, cushioned surfaces that bound recess 68 and the facing areas of latch ears 68.

Referring to FIG. 4, retainer member 42 includes an upper mounting section 76 having a transverse passage within which a pivot pin 78 is received. Pivot pin 78 has a length greater than the width of mounting section 76, so that end portions of pivot pin 78 extend outwardly from the side surfaces of mounting section 76. At its opposite end, retainer member 42 defines a finger grip section 80, which includes a neck 82 and a pair of outwardly extending legs 84 that cooperate to define finger-receiving recesses 86 located on opposite sides of neck 82. Adjacent finger grip section 80, retainer member 42 defines a latch section 88, which includes a transverse passage through which a latch pin 90 extends. As with pivot pin 78, latch pin 90 has a length greater than the width of latch section 88, so that the end portions of latch pin 90 extend outwardly from the side surfaces of latch section 88.

Between mounting section 76 and latch section 88, retainer member 42 defines an article engagement section that includes an inwardly extending engagement member 92, which is formed as a protrusion or other area of increased thickness of retainer member 42.

Retainer member 42 is preferably formed of a stretchable and resilient material, such as rubber having a durometer of approximately 60+/−5 Shore A, although it is understood that any other type of suitable stretchable and resilient material having a satisfactory degree of resiliency may be employed.

Retainer member 42 is secured to retainer bracket 40 by positioning mounting section 76 within recess 56 in retainer bracket upper wall 46, such that the passage in mounting section 76 is aligned either with openings 60 or with openings 62 in mounting tabs 58. Pivot pin 78 is then inserted through the selected openings 60 or 62 and through the transverse passage in mounting section 76. In this manner, latch member 42 is pivotably mounted to upper wall 46 within recess 56, for movement about a transverse pivot axis defined by pivot pin 78.

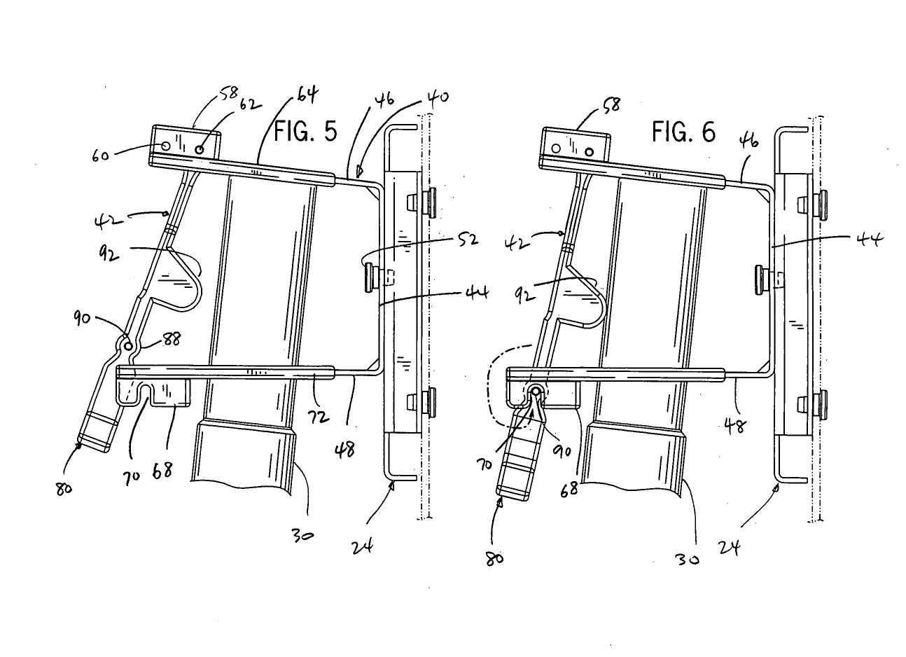

Retainer member 42 is pivotable about pivot pin 78 for movement between an open position and a closed position. In the open position, retainer member 42 is rotated about pivot pin 78 in a clockwise direction (with reference to FIGS. 5 and 6), so that the entrance to recess 66 in lower wall 48 is open and unobstructed. Retainer member 42 may be placed in an over-center position relative to retainer bracket upper wall 46, in which an acute angle is defined between retainer member 42 and upper wall 46. Retainer member 42 is maintained in this position by gravity, and is completely removed from the entrance to recess 66 and from the area between upper wall 46 and lower wall 48. In the closed position, retainer member 42 is moved downwardly so as to extend between upper wall 46 and lower wall 48 and into the entrance to recess 66, in a manner to be explained.

When the upper end of an article, such as a gun barrel 30, is to be maintained in position within the interior of rack R, the lower end of the article is engaged with lower end support 22. Retainer member 42 is placed in the open position as described above, and the upper end of the article is moved into recess 66 in lower wall 48. Retainer bracket 40 is positioned and configured so that the upper end of the article is located below upper wall 46, and so that the entire periphery of the article is positioned within recess 66. In the illustrated embodiment, the outward extent of the article is positioned rearwardly of latch ears 68, as shown in FIGS. 5 and 6. The resilient material 72, which coats the edges of lower wall 48 that define recess 66, provides a cushioned support for the surfaces of the article that engage the edges of recess 66.

To retain the upper end of the article, retainer member 42 is grasped by a user and pivoted from the open position as described above, to a closed and latched position as shown in FIG. 6. To accomplish this, the user engages two fingers within recesses 86 of latch member finger grip section 80, and then pivots retainer member 42 about pivot pin 78 toward the closed position of FIG. 5, in which retainer member 42 is moved into the space between upper wall 46 and lower wall 48 and over the entrance to recess 66. As retainer member 42 is moved to the closed position in this manner, engagement member 92 of retainer member 42 engages the outwardly facing surface of the article, as shown in FIG. 5. The user applies tension to retainer member 42 by pulling on retainer member 42, which stretches retainer member 42 due to the resilient and stretchable nature of the material from which retainer member 42 is formed, to move latch pin 90 downwardly to a position in which latch pin 90 is located below the lower edges of latch ears 68. The user then utilizes finger grip section 80 to move the lower end of latch member 42 inwardly as shown in FIG. 6, to place the end areas of latch pin 90 into alignment with notches 70 in latch ears 68. The user then releases finger grip section 80, and the resilient nature of latch member 42 functions to contract retainer member 42 and to draw latch pin 90 into notches 70. In this manner, retainer member 42 is latched in the closed position between upper wall 46 and lower wall 48 and in engagement with the article.

As retainer member 42 is moved to the latched, closed position as described above, the resiliency of engagement member 92 functions to grip the outer surface of the article, and to conform the facing surface of engagement member 92 with the surface of the article. In addition, the stretchable and resilient nature of the material functions to bow the area of retainer member 42 outwardly between pivot pin 78 and latch pin 90, which biases engagement member 92 against the facing surface of the article. With retainer member 42 latched in the closed position as shown and described, the upper end of the article is securely engaged with retainer bracket 40 and is prevented from movement within the interior of rack R. The retainer bracket arms on either side of recess 66 prevent lateral movement of the upper end of the article, and retainer member 42 prevents inward or outward movement of the article. In addition, the upper wall 46 of retainer bracket 40 prevents upward movement of the article. Lower supports 22 include upstanding walls or other structure that define a recess or the like within which the lower end of the article is received. With this construction, the prevention against upward movement provided by the retainer bracket upper wall 46 functions to maintain the lower end of the article within the recess defined by the lower support 22, so that the article is securely maintained in position and unable to move without disengagement of retainer member 42.

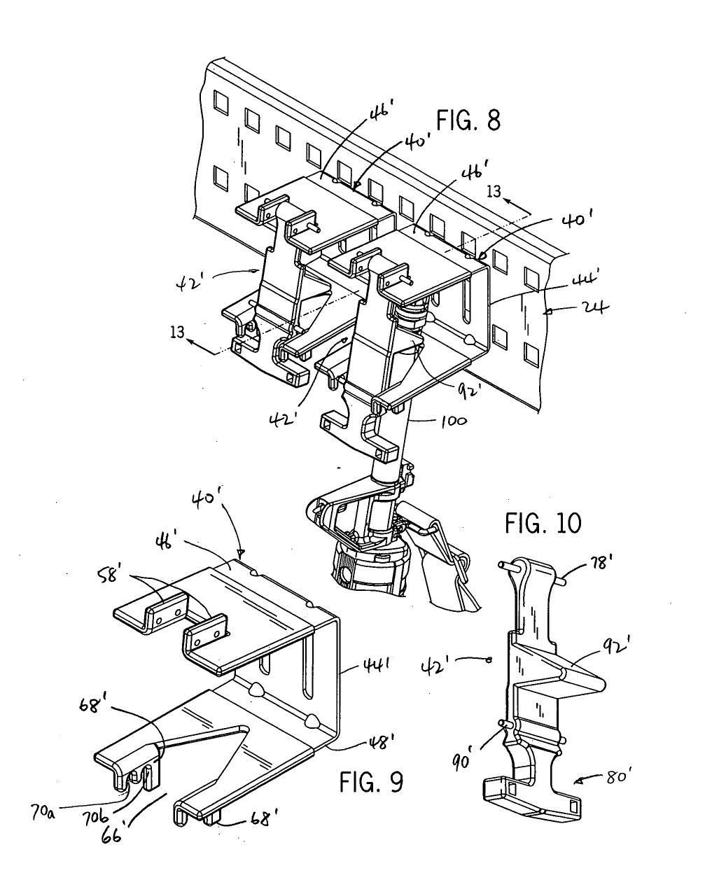

FIGS. 8-12 illustrate another embodiment of an upper retainer assembly, shown at 28′, in accordance with the present invention, and like reference characters will be used where possible to facilitate clarity. In this embodiment, a retainer member 42′ is constructed similarly to retainer member 42 as described with respect to FIGS. 1-7, and includes an engagement member 92′ having a greater thickness than engagement member 92 described above. Engagement member 92′ has a generally triangular cross section. Retainer bracket 40′ has an upper wall 46′ formed similarly to upper wall 46 as described above, and a lower wall 48′ which includes a recess 66′ that is generally V-shaped (as opposed to the generally U-shaped configuration of recess 66 described above). In this embodiment, latch ears 68′ include a pair of notches, shown at 70a, 70b. With this construction, latch pin 90 of retainer member 42′ can be engaged either with notches 70a or with notches 70b, to provide variable position engagement of the lower end of retainer member 42′ with lower wall 48′.

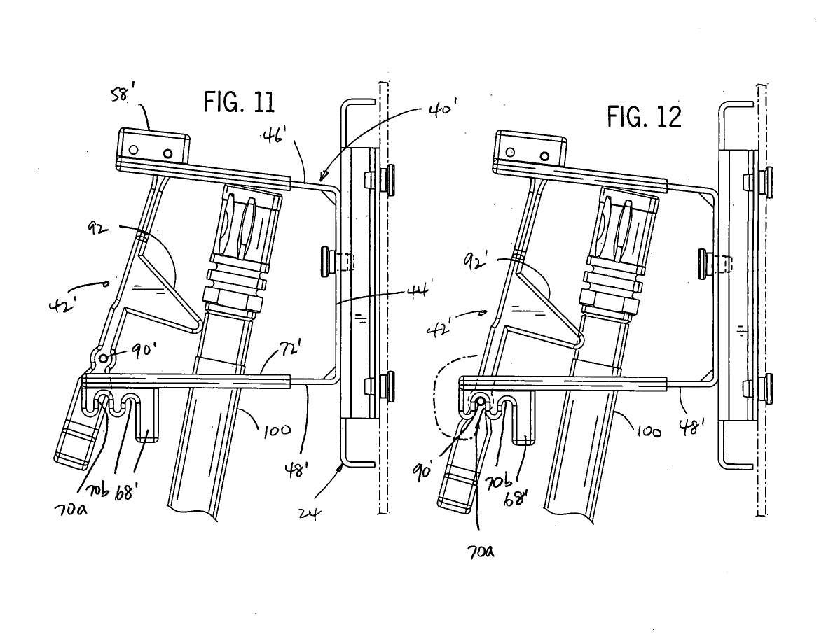

As shown in FIGS. 7, 10 and 11, a relatively small diameter article, such as the end of a small diameter rifle barrel 100, can be positioned within recess 66′ in the same manner as described above, so as to rest against the edges of recess 66′ toward the rear of recess 66′. As in the prior embodiment, lower wall 48′ includes a coating of resilient material at the areas that border recess 66′, to provide cushioned support for the article. The user then pivots retainer member 42′ to the closed position of FIG. 10 and the latched position of FIG. 11, in the same manner as described above with respect to latch member 42. As latch member 42′ is moved to the closed position, the inner end of engagement member 92 engages the facing surface of the article, and conforms to the surface of the article as described above so as to bias the article against the edges of recess 66′ and to securely retain the upper end of the article in position within the interior of rack R. It can be appreciated that differently dimensioned articles can be placed within recess 66′, and latch pin 90 of retainer member 42 can be placed either into notches 70a or 70b of latch ears 68′ to provide the desired degree of force on the article, according to the article dimensions, in order to securely retain the article within recess 66′.

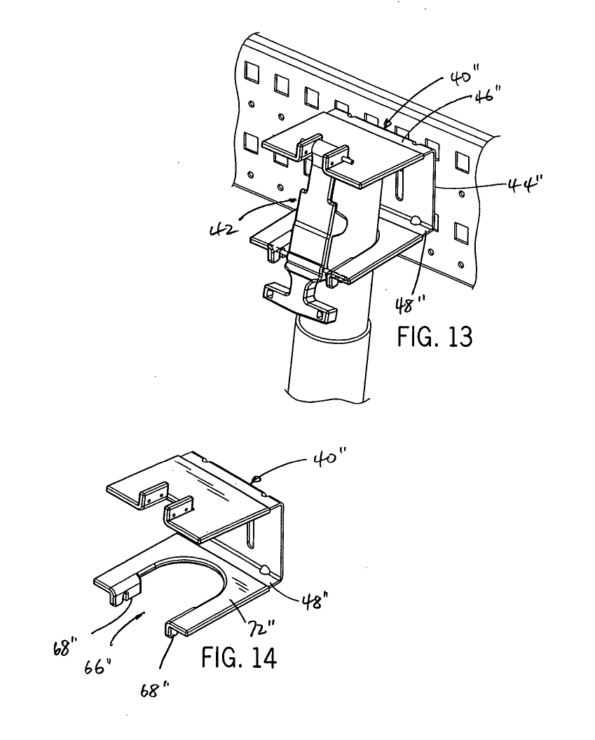

FIGS. 13 and 14 illustrate a retainer assembly 28″ having generally the same configuration and operation as shown and described with respect to FIGS. 1-7. In this embodiment, retainer bracket 40″ has a lower wall 48″ defining a U-shaped recess 66″ that is configured to receive a slightly differently shaped article, such as the end of a firearm barrel having a different diameter that that illustrated in FIGS. 1-7. In all other respects, the construction and operation of the retainer assembly 28″ of FIGS. 13 and 14 is the same as described previously in connection with FIGS. 1-7.

While the invention has been shown and described with respect to certain embodiments, it is understood that various alternatives and modifications are possible and are contemplated as being within the scope of the present invention. For example, and without limitation, the invention has been shown with respect to maintaining the upper end of an article in position with the interior of a cabinet or the like. It is also understood that the invention may be used to secure the lower end of an article in a desired position. Accordingly, the references to orientation (e.g. “upper” and “lower”) used in the preceding description are understood to be for convenience, and are not limiting on the scope of the invention. In this configuration, the retaining bracket 40 is reversed such that wall 46 defines the lower wall of the cradle or bracket, and the lower end of the article is located adjacent the inner surface of the wall 46. The retainer member 42 is pivoted upwardly to the closed and latched positions. It is also contemplated that the upper wall of the bracket may include an opening or recess through which the end of the article extends. In an embodiment such as this, the upper end of the article need not be located below the inner surface of the upper wall, but rather may be placed through an opening or into a recess in the upper wall as the article is moved into position. In addition, while the invention has been shown and described with respect to engaging the ends of firearms or related accessories, it is also understood that the invention may be used to maintain the position of any type of article in a desired orientation.

Various alternatives and embodiments are contemplated as being within the scope of the following claims particularly pointing out and distinctly claiming the subject matter regarded as the invention.

1. A retainer arrangement for selectively maintaining an article in a position, wherein the article defines an end, comprising:
article receiving structure defining an outwardly open recess configured to receive the article at a location adjacent the end of the article; and
a retainer member movably mounted to the article receiving structure for movement between an open position in which the retainer member is positioned to allow the article to be placed into or removed from the recess, and a closed position in which the retainer member is positioned within the recess, wherein the retainer member is releasably engaged with the article receiving structure when in the closed position and engages the article to prevent outward movement of the article from the recess.

2. The retainer arrangement of claim 1, wherein the article receiving structure comprises a cradle member having a pair of arms which at least in part define the recess.

3. The retainer arrangement of claim 2, wherein the cradle member includes an outer wall spaced vertically from the pair of arms, wherein the end of the article is located inwardly of the outer wall.

4. The retainer arrangement of claim 3, wherein the retainer member is pivotably mounted to the outer wall of the cradle member for movement between the open and closed positions.

5. The retainer arrangement of claim 4, wherein the retainer member is carried by the cradle member, and wherein the cradle member and the retainer member comprises a retaining subassembly that is configured to be mounted to a support area associated with a housing within which the article is located.

6. The retainer arrangement of claim 2, wherein the retainer member is pivotably mounted to the article receiving structure for movement between the open and closed positions, wherein the article receiving structure includes a retainer member engagement surface, and wherein at least a portion of the retainer member is stretchable and the retainer member includes engagement structure that engages the retainer member engagement surface when the retainer member is in the closed position, and wherein the retainer member is stretched during movement of the retainer member to the closed position and wherein, when the retainer member is in the closed position, the stretch of the retainer member biases the engagement structure of the retainer member against the retainer member engagement surface to maintain the retainer member in the closed position.

7. The retainer arrangement of claim 6, wherein the retainer member engagement surface of the article receiving structure comprises one or more recesses, and wherein the engagement structure of the retainer member comprises one or more pins that are engaged within the one or more recesses to releasably maintain the retainer member in the closed position and that are maintained in the one or more recesses by the stretch of the retainer member.

8. The retainer arrangement of claim 6, wherein the retainer member further includes a finger grip area located outwardly of the engagement structure, wherein the finger grip area is employed by the user to move the retainer member between the open and closed positions, and to apply tension to the retainer member so as to stretch the retainer member as the retainer member is moved from the open position to the closed position and vice versa.

9. The retainer arrangement of claim 6, wherein the retainer member includes a resilient article engagement member that extends into the recess and resiliently engages the article when the retainer member is in the closed position.

10. The retainer arrangement of claim 9, wherein the retainer member and the article engagement member are integrally formed of a resilient material.

11. A retainer for selectively maintaining an article in an upright position, wherein the article defines a lower end and an upper end, comprising:
a cradle member defining an outwardly and downwardly open recess configured to receive the article at a location below the upper end of the article, wherein the cradle member defines a retainer member mount located above the recess and a retainer member engagement area located below the retainer member mount; and
a stretchable retainer member pivotably mounted to the retainer member mount of the cradle member, wherein the retainer member is pivotably movable between an open position in which the retainer member is positioned to allow the article to be placed into or removed from the recess, and a closed position in which the retainer member is positioned within the recess, wherein the retainer member includes an engagement section that engages the retainer member engagement area when the retainer member is in the closed position, and wherein the retainer member is stretched during movement of the retainer member to the closed position and wherein, when the retainer member is in the closed position, the stretch of the retainer member biases the engagement section of the retainer member against the retainer member engagement area to releasably maintain the retainer member in the closed position.

12. The retainer of claim 11, wherein the stretchable retainer member includes an inwardly extending resilient article engagement member that is configured to engage the article when the retainer member is in the closed position.

13. The retainer of claim 12, wherein the retainer member mount defines a mounting recess, and wherein the stretchable retainer member includes a mounting section disposed within the mounting recess and pivotably mounted to the retainer member mount adjacent the mounting recess.

14. The retainer of claim 13, wherein the retainer member mount comprises an upper wall spaced vertically above the recess defined by the cradle member within which the article is received, and wherein the upper end of the article is located below the upper wall.

15. The retainer of claim 12, wherein the retainer member engagement area of the cradle member comprises one or more retaining recesses, and wherein the engagement structure of the retainer member comprises one or more pins that are engaged within the one or more retaining recesses to releasably maintain the retainer member in the closed position, wherein the one or more pins are maintained in the one or more retaining recesses by the stretch of the retainer member.

16. The retainer of claim 12, wherein the retainer member engagement area includes first and second discrete engagement areas spaced apart from each other in an inward-outward direction to vary the position of the retainer member relative to the upper end of the article when the engagement structure of the retainer member is engaged with one of the first and second discrete engagement areas.

17. The retainer of claim 12, wherein the retainer member further includes a finger grip area located outwardly of the resilient article engagement member, wherein the finger grip area is employed by the user to move the retainer member between the open and closed positions, and to apply tension to the retainer member so as to stretch the retainer member as the retainer member is moved from the open position to the closed position and vice versa.

18. A method of maintaining an article in a position, wherein the article defines an end, comprising the acts of:
positioning the end of the article in an outwardly open recess;
engaging a retainer member with the article adjacent the end of the article, wherein the retainer member is movably mounted adjacent the recess for movement between an open position in which the retainer member is positioned to allow the article to be placed into or removed from the recess, and a closed position in which the retainer member is positioned within the recess; and
releasably securing the retainer member in the closed position to maintain the retainer member in engagement with the article to prevent outward movement of the article from the recess.

19. The method of claim 18, wherein the retainer member is pivotably mounted to a retainer mount, located adjacent the recess, for movement about a pivot axis, and wherein the act of moving the retainer member between the open and closed positions is carried out by pivoting the retainer member about the pivot axis.

20. The method of claim 19, wherein the recess is defined by a cradle member and wherein the retainer member is carried by the cradle member, wherein the cradle member and the retainer member comprises a retaining subassembly, and further comprising the act of securing the retaining subassembly to a support area associated with a housing within which the article is located.

21. The method of claim 19, further comprising a retainer member engagement surface adjacent the recess, wherein the act of releasably securing the retainer member in the closed position is carried out by releasably securing the retainer member with the retainer member engagement surface.

22. The method of claim 21, wherein the retainer member includes engagement structure that engages the retainer member engagement surface when the retainer member is in the closed position, and wherein act of releasably securing the retainer member in the closed position is carried out by stretching the retainer member during movement of the retainer member to the closed position, wherein the stretch of the retainer member biases the engagement structure of the retainer member against the retainer member engagement surface to maintain the retainer member in the closed position.

23. The method of claim 22, wherein the act of stretching the retainer member during movement of the retainer member to the closed position is carried out by grasping a finger grip area of the retainer member located outwardly of the engagement structure, and using the finger grip area to apply tension to the retainer member so as to stretch the retainer member as the retainer member is moved from the open position to the closed position and vice versa.

24. The method of claim 22, wherein the retainer member includes a resilient article engagement member, and further comprising the act of engaging the article with the resilient article engagement member when the retainer member is in the closed position.

25. The method of claim 22, wherein the retainer member engagement surface includes first and second discrete engagement areas spaced apart from each other in an inward-outward direction relative to the recess, and including the act of engaging the engagement structure of the retainer member with a selected one of the first and second discrete engagement areas to vary the position of the retainer member relative to the upper end of the article.
